(19) United States
(12) Patent Application Publication
(10) Pub. No.: US 2024/0032025 A1
(43) Pub. Date: Jan. 25, 2024

(54) PHYSICAL UPLINK SHARED CHANNEL REPETITION SCHEDULED WITH MULTIPLE DOWNLINK CONTROL INFORMATION OVER MULTIPLE TRANSMISSION AND RECEPTION POINTS

(71) Applicant: Telefonaktiebolaget LM Ericsson (publ), Stockholm (SE)

(72) Inventors: Shiwei GAO, Nepean (CA); Siva MURUGANATHAN, Stittsville (CA)

(73) Assignee: Telefonaktiebolaget LM Ericsson (publ), Stockholm (SE)

(21) Appl. No.: 18/040,839

(22) PCT Filed: Aug. 5, 2021
(86) PCT No.: PCT/IB2021/057226

§ 371 Date: Feb. 7, 2023

Related U.S. Application Data
(60) Provisional application No. 63/062,918, filed on Aug. 7, 2020.

(51) Int. Cl. H04W 72/1268; H04L 5/00; H04W 72/232

(52) U.S. Cl. CPC H04W 72/1268; H04L 5/0053; H04W 72/232

(57) ABSTRACT

A user equipment (UE) may receive a first physical downlink control channel (PDCCH) that carries a first downlink control information (DCI) in a first Control Resource Set (CORESET). The first DCI may indicate a first set of parameters for a first set of physical uplink shared channel (PUSCH) transmission occasions. The UE may receive, prior to the end of the first set of PUSCH transmission occasions, a second PDCCH that carries a second DCI in a second CORESET. The second DCI may indicate a second set of parameters for a second set of PUSCH transmission occasions. The UE may transmit data in the first set of PUSCH transmission occasions according to the first set of parameters. The UE may transmit data (e.g., the same data) in the second set of PUSCH transmission occasions according to the second set of parameters.

### TECHNICAL FIELD

This disclosure relates to apparatuses, methods, and systems for physical uplink shared channel (PUSCH) repetition. Some aspects of this disclosure relate to PUSCH repetition scheduled with multiple downlink control information (DCI) over multiple transmission and receptions points (TRPs).

### BACKGROUND

The next generation mobile wireless communication system, which is known as 5G, New Radio (NR), or Next Generation (NG), will support a diverse set of use cases and a diverse set of deployment scenarios, including deployment at both low frequencies (below 6 GHz) and very high frequencies (up to 10's of GHz).

1.1 NR Frame Structure and Resource Grid

NR uses Cyclic Prefix Orthogonal Frequency Division Multiplexing (CP-OFDM) in both downlink (e.g., from a network node, such as an NG NodeB (gNB), or base station, to a user equipment (UE)) and uplink (e.g., from UE to gNB). Discrete Fourier transform (DFT) spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically in slot basis. An example is shown in FIG. 1 with a 14-symbol slot, where the first two symbols contain physical downlink control channel (PDCCH) and the rest contains physical shared data channel, either physical downlink shared channel (PDSCH) or physical uplink shared channel (PUSCH).

Different subcarrier spacing values are supported in NR. The supported subcarrier spacing values (also referred to as different numerologies) are given by Δf=(15×2^{μ}) kHz, where μ∈1,2,3,4. Δf=15 kHz is the basic subcarrier spacing. The slot durations at different subcarrier spacings is given by ½^{μ} ms.

In the frequency domain, a system bandwidth is divided into resource blocks (RBs), each corresponding to 12 contiguous subcarriers. The RBs are numbered starting with 0 from one end of the system bandwidth. The basic NR physical time-frequency resource grid is illustrated in FIG. 2, where only one resource block (RB) within a 14-symbol slot is shown. One OFDM subcarrier during one OFDM symbol interval forms one resource element (RE).

In NR Rel-15, uplink data transmission can be dynamically scheduled using PDCCH. A UE first decodes uplink grants in PDCCH and then transmits data over PUSCH based on the decoded control information in the uplink grant such as modulation order, coding rate, uplink resource allocation, etc.

In addition to dynamic scheduling of PUSCH, there is also a possibility to configure semi-persistent transmission of PUSCH using configured grants (CGs). There are two types of CG-based PUSCH defined in NR Rel-15. In CG type 1, a periodicity of PUSCH transmission as well as the time domain offset are configured by Radio Resource Control (RRC). In CG type 2, a periodicity of PUSCH transmission is configured by RRC and then the activation and release of such transmission is controlled by downlink control information (DCI) (e.g., with a PDCCH).

In NR, it is possible to schedule a PUSCH with time repetition, by the RRC parameter pusch-AggregationFactor (for dynamically scheduled PUSCH), and repK (for PUSCH with UL configured grant). In this case, the PUSCH is scheduled but transmitted in multiple adjacent slots (if the slot is available for UL) up until the number of repetitions as determined by the configured RRC parameter.

In the case of PUSCH with UL configured grant, the redundancy version (RV) sequence to be used is configured by the repK-RV field when repetitions are used. If repetitions are not used for PUSCH with UL configured grant, then the repK-RV field is absent.

In NR Release-15, there are two mapping types supported, Type A and Type B, applicable to PDSCH and PUSCH transmissions. Type A is usually referred to as slot-based, while Type B transmissions may be referred to as non-slot-based or mini-slot-based. Mini-slot transmissions can be dynamically scheduled. For NR Rel-15, mini-slot transmissions: (i) can be of length 7, 4, or 2 symbols for downlink and of any length for uplink, (ii) can start and end in any symbol within a slot, and (iii) may not cross the slot-border.

One of the 2 frequency hopping modes, inter-slot and intra-slot frequency hopping, can be configured via higher layers for PUSCH transmission in NR Rel-15 in information element (IE) PUSCH-Config for dynamically scheduled PUSCH transmissions or IE configuredGrantConfig for type1 and type2 CG based PUSCH transmissions.

1.2 NR Release 16 PUSCH Enhancements

In NR Release 16, PUSCH repetition enhancements were made for both PUSCH mapping type A and type B for the purposes of further latency reduction.

1.2.1 PUSCH Repetition Type A (Slot Based) Enhancements

In NR Rel-15, the number of aggregated slots for both dynamic grant and configured grant Type 2 are RRC configured. In NR Rel-16, this was enhanced so that the number of repetition can be dynamically indicated (e.g., changed from one PUSCH scheduling occasion to the next). That is, in addition to the starting symbol S, and the length L of the PUSCH, a number of nominal repetitions K is also signaled as part of time-domain resource allocation (TDRA). Furthermore, the maximum number of aggregated slots was increased to K=16 to account for DL heavy time division duplex (TDD) patterns. Inter-slot and intra-slot frequency hopping can be applied for Type A repetition. The number of repetitions K is nominal because some slots may be DL slots and are then skipped for PUSCH transmissions. So, K is the maximal number of repetitions possible.

1.2.2 PUSCH Repetition Type B (Mini-Slot Based) Enhancements

PUSCH repetition Type B applies both to dynamic and configured grants. Type B PUSCH repetition can cross the slot boundary in Rel-16. When scheduling a transmission with PUSCH repetition Type B, in addition to the starting symbol S, and the length L of the PUSCH, a number of nominal repetitions K is signaled as part of time-domain resource allocation (TDRA) in NR Rel-16. Inter-slot frequency hopping and inter-repetition frequency hopping can be configured for Type B repetition. To determine the actual time domain allocation of Type B PUSCH repetitions, a two-step process is used. The first step allocates K nominal repetitions of length L back-to-back (adjacent in time), ignoring slot boundaries and TDD pattern. In the second step, if a nominal repetition crosses a slot boundary or occupies symbols not usable for UL transmission (e.g. UL/DL switching points due to TDD pattern), the offending nominal repetition may be split into two or more shorter actual repetitions. If the number of potentially valid symbols for PUSCH repetition type B transmission is greater than zero for a nominal repetition, the nominal repetition consists of one or more actual repetitions, where each actual repetition consists of a consecutive set of potentially valid symbols that can be used for PUSCH repetition Type B transmission within a slot.

Although the term “PUSCH repetition” is used in this document, other terms, such as “PUSCH transmission occasion,” can be used interchangeably.

In NR Rel-15/16, when PUSCH is repeated according to PUSCH repetition Type A, the PUSCH is limited to a single transmission layer.

1.3 Multi-DCI Scheduling

In NR Rel-16, multi-DCI scheduling is introduced in which a UE may expect to receive two DCIs each scheduling a PDSCH or a PUSCH in the same slot, even on overlapping resources. A CORESETPOOLIndex can be configured in Control Resource Set (CORESET) with value 0 or 1 in PDCCH-Config IE. The two DCIs and corresponding PDSCHs may be sent to the UE from two different transmission and reception points (TRPs). The two DCIs are transmitted in two CORESETs belonging to different CORESET pools (e.g., with CORESETPoolIndex 0 and 1, respectively), each pool associated with a different TRP. The two PDSCHs or PUSCHs belong to two different hybrid automatic repeat request (HARQ) processes and may be scheduled as either fully, partially overlapping, or non-overlapping in time and frequency resources.

1.4 Current NR PUSCH Scheduling Restrictions

According to 3GPP TS 38.214 v16.2.0, “[t]he UE is not expected to be scheduled to transmit another PUSCH by DCI format 0_0, 0_1 or 0_2 scrambled by C-RNTI or MCS-C-RNTI for a given HARQ process until after the end of the expected transmission of the last PUSCH for that HARQ process.” This means that the reception of PDCCH for next PUSCH cannot occur until the previous PUSCH corresponding to the same HARQ process has been transmitted. This is illustrated in FIG. 3, where PDCCH #2 for PUSCH #2 needs to be received after PUSCH #1 is transmitted. In FIG. 3, an illustration of this PUSCH scheduling restriction is given. In this figure, PDCCH #1 (i.e., the DCI carried by PDCCH #1) and PDCCH #2 (i.e., the DCI carried by PDCCH #2), schedule PUSCH corresponding to the same HARQ process. Hence, as shown in the figure, PDCCH #2 can only be received by the UE after the end of the PUSCH transmission scheduled by PDCCH #1.

For any two HARQ process IDs in a given scheduled cell, if the UE is scheduled to start a first PUSCH transmission starting in symbol j by a PDCCH ending in symbol i, the UE is not expected to be scheduled to transmit a PUSCH starting earlier than the end of the first PUSCH by a PDCCH that ends later than symbol i. This is illustrated in FIG. 4, where PDCCH #2 is received after PDCCH #1 and is only allowed to schedule a PUSCH with HARQ ID y that starts after the end of the first PUSCH with HARQ ID x scheduled by PDCCH #1. This is so called in-order scheduling.

If a UE is configured by higher layer parameter PDCCH-Config that contains two different values of CORESETPoolIndex in ControlResourceSet for the active bandwidth part (BWP) of a serving cell, out of order scheduling is supported (e.g., for any two HARQ process IDs in a given scheduled cell). If the UE is scheduled to start a first PUSCH transmission starting in symbol j by a PDCCH associated with a value of CORESETpoolIndex ending in symbol i, the UE can be scheduled to transmit a PUSCH starting earlier than the end of the first PUSCH by a PDCCH associated with a different value of CORESETpoolIndex that ends later than symbol i. The two PUSCHs are non-overlapping in time. This is illustrated in FIG. 5, where PDCCH #2 is received after PDCCH #1 but can schedule PUSCH #2 before PUSCH #1, which is scheduled by PDCCH #1.

1.5 Spatial Relation for UL Channels

Spatial relation is used in NR to refer to a relationship between an UL reference signal (RS) to be transmitted such as PUCCH/PUSCH demodulation reference signal (DMRS) and another previously transmitted or received RS, which can be either a DL RS (e.g., channel state information RS (CSI-RS) or synchronization signal block (SSB)) or an UL RS (e.g., sounding reference signal (SRS)). This is defined from a UE perspective.

If an UL transmitted RS is spatially related to a DL RS, the UE should transmit the UL RS in the opposite (reciprocal) direction from which it received the DL RS previously. More precisely, the UE should apply the “same” Transmit (Tx) spatial filtering configuration for the transmission of the UL RS as the Rx spatial filtering configuration it used to receive the spatially related DL RS previously. Here, the terminology “spatial filtering configuration” may refer to the antenna weights that are applied at either the transmitter or the receiver for data/control transmission/reception. Another way to describe this is that the same “beam” should be used to transmit the signal from the UE as was used to receive the previous DL RS signal. The DL RS is also referred as the spatial filter reference signal.

On the other hand, if a first UL RS is spatially related to a second UL RS, then the UE should apply the same Tx spatial filtering configuration for the transmission for the first UL RS as the Tx spatial filtering configuration it used to transmit the second UL RS previously. In other words, same beam is used to transmit the first and second UL RSs, respectively.

Since the UL RS is associated with a layer of PUSCH or PUCCH transmission, it is understood that the PUSCH/PUCCH is also transmitted with the same TX spatial filter as the associated UL RS.

1.6 PUSCH Transmission Schemes

In NR, there are two transmission schemes specified for PUSCH: (1) Codebook based PUSCH and (2) Non-Codebook based PUSCH.

1.6.1 Codebook Based PUSCH

Codebook based PUSCH in NR is enabled if higher layer parameter txConfig=‘codebook’. For dynamically scheduled PUSCH and configured grant PUSCH type 2, the Codebook based PUSCH transmission scheme can be summarized as follows. The UE transmits one or two SRS resources (e.g., one or two SRS resources configured in a SRS resource set associated with the higher layer parameter usage of value ‘CodeBook’). The network node (e.g., gNB) determines a preferred Multiple Input Multiple Output (MIMO) transmit precoder for PUSCH (e.g., transmit precoding matrix indicator or TPMI) from a codebook and the associated number of layers corresponding to the one or two SRS resources. The network node indicates a selected SRS resource via a 1-bit “SRS resource indicator” (SRI) field if two SRS resources are configured in the SRS resource set. The SRI field is not indicated in DCI if only one SRS resource is configured in the SRS resource set. The network node indicates a TPMI and the associated number of layers corresponding to the indicated SRS resource (in case 2 SRS resources are used) or the configured SRS resource (in case of 1 SRS resource is used). The UE performs PUSCH transmission using the TPMI and number of layers indicated. If one SRS resource is configured in the SRS resource set associated with the higher layer parameter usage of value “CodeBook”, then the PUSCH DMRS is spatially related to the most recent SRS transmission in this SRS resource. If two SRS resources are configured in the SRS resource set associated with the higher layer parameter usage of value “CodeBook”, then the PUSCH DMRS is spatially related to the most recent SRS transmission in the SRS resource indicated by the SRI field. Spatial relation of a SRS resource is configured by RRC and can be updated by a Medium Access Control (MAC) Control Element (CE) command

1.6.2 Non-Codebook Based PUSCH

Non-Codebook based UL transmission is available in NR, enabling reciprocity-based UL transmission. Non-Codebook based PUSCH in NR is enabled if higher layer parameter txConfig=‘noncodebook’.

By assigning a DL CSI-RS to the UE, the UE can measure and deduce suitable precoder weights for PUSCH transmission of up to four spatial layers. The candidate precoder weights are transmitted using up to four single-port SRS resources corresponding to the spatial layers. Subsequently, the gNB indicates the transmission rank and the SRS resources using the SRI field.

The UE shall transmit PUSCH using the same antenna ports as the SRS port(s) in the SRS resource(s) indicated by SRI(s),

1.7 Ultra-Reliable Low Latency Communication (URLLC) Over Multiple TRPs

In NR, both eMBB (enhanced mobile broad band) and URLLC are supported. URLLC simply represents some very strict requirements on both reliability and latency.

In some deployments at high carrier frequencies such as over 20 GHz, there could be link outages between a TRP and the UE due to channel blocking by geometrical objects along the link. A TRP located at a different location could create an alternative link to the UE and would add extra reliability for transmissions.

Reliable PDSCH transmission utilizing multiple TRPs has been introduced in NR Rel-16, in which a single DCI is used to schedule a transport block (TB) over multiple TRPs to achieve additional diversity. One of the methods is to transmit multiple PDSCHs, each with different redundancy versions (RVs) of a same transport block (TB), over different TRPs. In the UE, the PDSCH signals received from different TRPs are soft combined to achieve reliable PDSCH reception.

In NR Rel-17, it has been proposed to introduce similar enhancements for PUSCH with multiple TRPs by repeating a PUSCH towards different TRPs.

### SUMMARY

For physical uplink shared channel (PUSCH) repetition over multiple transmission and reception points (TRPs), a single downlink control information (DCI) based approach has been proposed in which multiple PUSCH transmissions to different TRPs are scheduled by a single DCI. To support such a scheme, new fields are needed in the existing DCI to indicate TRP specific parameters (e.g., SRS resource indicator (SRI), Transmitted Precoding Matrix Indicator (TPMI), power control command, etc.). This would add DCI overhead particularly if the DCI is also used for single TRP scheduling and, thus, the new fields are not relevant. In addition, the same modulation and coding scheme and resource allocation need to be used for PUSCH to different TRPs, which is not desirable as the channels to different TRPs can be different.

Aspects of the invention may overcome one or more of these problems by scheduling multiple PUSCH transmissions for a same transport block (TB) towards multiple TRPs by multiple DCIs. Each of the multiple DCIs may schedule one or more PUSCH transmissions to one TRP. The multiple PUSCH transmissions may be time division multiplexed in different slots (or mini-slots or subslots).

Using multiple DCIs to schedule multiple PUSCH transmissions for a same TB towards multiple TRPs may provide the benefit of requiring minimum change of the current 3gpp spec, such as DCI formats, and allowing the use of different resources, modulation coding schemes (MCSs), and others scheduling parameter flexibly for different TRPs to adapt to different channel conditions. Using multiple DCIs to schedule multiple PUSCH transmissions for a same TB towards multiple TRPs may additionally or alternatively improve PDCCH reliability in case that one TRP is blocked.

One aspect of the invention may provide a method performed by a user equipment (UE). The UE may include receiving a first physical downlink control channel (PDCCH) that carries a first downlink control information (DCI) in a first Control Resource Set (CORESET). The first DCI may indicate a first set of parameters for a first set of physical uplink shared channel (PUSCH) transmission occasions. The method may include receiving, prior to the end of the first set of PUSCH transmission occasions, a second PDCCH that carries a second DCI in a second CORESET. The second DCI may indicate a second set of parameters for a second set of PUSCH transmission occasions. The method may include transmitting data in the first set of PUSCH transmission occasions according to the first set of parameters. The method may include transmitting data in the second set of PUSCH transmission occasions according to the second set of parameters.

In some aspects, the first set of parameters may include a first starting slot or sub-slot, a first Sounding Resource Indicator (SRI), a first uplink Transmission Control Indicator (TCI) state, a first Transmit Precoding Matrix Indicator (TPMI), and/or a first number N1 of PUSCH transmission occasions. In some aspects, the second set of parameters may include a second starting slot or sub-slot, a second SRI, a second uplink TCI state, a second TPMI, and/or a second number N2 of PUSCH transmission occasions.

In some aspects, the first CORESET and the second CORESET may be the same. In some aspects, the first CORESET and the second CORESET may be different.

In some aspects, the first CORESET may be activated with a first downlink transmission configuration indicator (TCI) state, and the second CORESET may be activated with a second downlink TCI state. In some aspects, the first and second downlink TCI states may be the same. In some aspects, the first and second downlink TCI states may be different.

In some aspects, the first and the second CORESETs may be configured with different CORESET pool indices.

In some aspects, the first set of parameters may include a first starting slot or sub-slot, the second set of parameters may include a second starting slot or sub-slot, transmitting data in the first set of PUSCH transmission occasions may include transmitting data in N1 consecutive slots or sub-slots starting from the first starting slot or sub-slot, and transmitting the data in the second set of PUSCH transmission occasions may include transmitting the data in N2 consecutive slots or sub-slots starting from the second starting slot or sub-slot.

In some aspects, the first DCI and the second DCI may be received in a same slot. In some aspects, the first DCI and the second DCI may be received in different slots.

In some aspects, the first set of PUSCH transmission occasions may include a first number N1 of PUSCH transmission occasions, and the second set of PUSCH transmission occasions may include a second number N2 of PUSCH transmission occasions. In some aspects, the N1 PUSCH transmission occasions and the N2 PUSCH transmission occasions may be associated with a same hybrid automatic repeat request (HARQ) process number. In some aspects, the N1 PUSCH transmission occasions and the N2 PUSCH transmission occasions may be associated with a same value of New Data Indicator (NDI).

In some aspects, the N1 PUSCH transmission occasions may be associated with a first spatial relation, the N2 PUSCH transmissions may be associated with a second spatial relation, and the first and second spatial relations may be different. In some aspects, a sounding reference signal resource indicator (SRI) field in the first DCI may indicate a first SRI and the first spatial relation, and an SRI field in the second DCI may indicate a second SRI and the second spatial relation.

In some aspects, the N1 PUSCH transmission occasions and the N2 PUSCH transmission occasions may not overlap in time. In some aspects, the N1 PUSCH transmission occasions may be transmitted at different times or slots than the N2 PUSCH transmission occasions. In some aspects, the N1 PUSCH transmission occasions may be transmitted at the same time as the N2 PUSCH transmission occasions. In some aspects, the N1 PUSCH transmission occasions may be transmitted on different frequency resources than the N2 PUSCH transmission occasions. In some aspects, the N1 PUSCH transmission occasions may be transmitted on the same frequency resources as the N2 PUSCH transmission occasions. In some aspects, the N1 PUSCH transmission occasions may be transmitted on different Multiple Input Multiple Output (MIMO) layers than the N2 PUSCH transmission occasions.

In some aspects, the first number N1 of PUSCH transmission occasions and the second number N2 of PUSCH transmission occasions may be positive integers. In some aspects, a time-domain resource allocation (TDRA) field of the first DCI may indicate the first number N1 of PUSCH transmission occasions, and a TDRA field of the second DCI may indicate the second number N2 of PUSCH transmission occasions.

In some aspects, the first set of parameters may be associated with a first transmission and reception point (TRP), the second set of parameters may be associated with a second TRP, and the first and second TRPs may be different. In some aspects, the data transmitted in the first set of PUSCH transmission occasions may be transmitted to the first TRP, and the data transmitted in the second set of PUSCH transmission occasions may be transmitted to the second TRP. In some aspects, the first DCI may indicate the first TRP by indicating a first sounding reference signal resource indicator (SRI), a first spatial relation, and/or a first uplink transmission configuration indicator (TCI) state, and the second DCI may indicate the second TRP by indicating a second SRI, a second spatial relation, and a second uplink TCI state. In some aspects, a first CORSET pool index of the first CORESET may indicate the first TRP, and a second CORSET pool index of the second CORESET may indicate the second TRP.

In some aspects, the data transmitted in the first set of PUSCH transmission occasions according to the first set of parameters and the data transmitted in the second set of PUSCH transmission occasions according to the second set of parameters may be the same.

Another aspect of the invention may provide a user equipment (UE) adapted to receive a first physical downlink control channel (PDCCH) that carries a first downlink control information (DCI) in a first Control Resource Set (CORESET). The first DCI may indicate a first set of parameters for N1 physical uplink shared channel (PUSCH) transmission occasions. The UE may be adapted to receive, prior to the end of the first set of PUSCH transmission occasions, a second PDCCH that carries a second DCI in a second CORESET. The second DCI may indicate a second set of parameters for N2 PUSCH transmission occasions. The UE may be adapted to transmit data in the N1 PUSCH transmission occasions according to the first set of parameters. The UE may be adapted to transmit data in the N2 PUSCH transmission occasions according to the second set of parameters.

Still another aspect of the invention may provide a method performed by a user equipment. The method may include receiving a first physical downlink control channel (PDCCH) that carries a first downlink control information (DCI) in a first Control Resource Set (CORESET). The first DCI and/or the first CORESET may indicate a first repetition number N1 and a first transmission and reception point (TRP). The method may include receiving a second PDCCH that carries a second DCI in a second CORESET. The second DCI and/or the second CORESET may indicate a second repetition number N2 and a second TRP, and the second TRP may be different than the first TRP. The method may include transmitting data associated with N1 physical uplink shared channel (PUSCH) transmissions associated with a transport block (TB) to the first TRP. The method may include transmitting data associated with N2 PUSCH transmissions associated with the same TB to the second TRP.

In some aspects, the first CORESET and the second CORESET may be the same. In some alternative aspects, the first CORESET and the second CORESET may be different.

In some aspects, the first CORESET may be activated with a first transmission configuration indicator (TCI) state, and the second CORESET may be activated with a second TCI state. In some aspects, the first and second TCI states may be the same. In some aspects, the first and second TCI states may be different. In some aspects, the first and the second CORESETs may be configured with different CORESET pool indices.

In some aspects, transmitting data associated with the N1 PUSCH transmissions to the first TRP may include transmitting data associated with N1 consecutive slots or sub-slots, and transmitting the data associated with the N2 PUSCH transmissions to the second TRP may include transmitting the data associated with N2 consecutive slots or sub-slots. In some aspects, the N1 PUSCH transmissions to the first TRP and the N2 PUSCH transmissions to the second TRP may be associated with a same hybrid automatic repeat request (HARQ) process identification (ID). In some aspects, the N1 PUSCH transmissions to the first TRP and the N2 PUSCH transmissions to the second TRP may be associated with a same value of New Data Indicator (NDI).

In some aspects, the first DCI and the second DCI may be received in the same slot. In some alternative aspects, the first DCI and the second DCI may be received in different slots. In some aspects, if the second DCI is received later than the first DCI, the second DCI may be received before the last of the N1 PUSCH transmissions scheduled by the first DCI is transmitted.

In some aspects, the N1 PUSCH transmissions to the first TRP may be associated with a first spatial relation, the N2 PUSCH transmissions to the second TRP may be associated with a second spatial relation, and the first and second spatial relations may be different. In some aspects, the first DCI may indicate the first spatial relation, and the second DCI may indicate the second spatial relation. In some aspects, the first spatial relation may represent the first TRP, and the second spatial relation may represent the second TRP. In some aspects, a sounding reference signal resource indicator (SRI) field in the first DCI may indicate the first spatial relation, and an SRI field in the second DCI may indicate the second spatial relation.

In some aspects, the N1 PUSCH transmissions to the first TRP and the N2 PUSCH transmissions to the second TRP may not overlap in time. In some aspects, the N1 PUSCH transmissions to the first TRP may be transmitted at different times or slots than the N2 PUSCH transmissions to the second TRP. In some aspects, the N1 PUSCH transmissions to the first TRP may be transmitted at the same time as the N2 PUSCH transmissions to the second TRP. In some aspects, the N1 PUSCH transmissions to the first TRP may be transmitted on different frequency resources than the N2 PUSCH transmissions to the second TRP. In some aspects, the N1 PUSCH transmissions to the first TRP may be transmitted on the same frequency resources as the N2 PUSCH transmissions to the second TRP. In some aspects, the N1 PUSCH transmissions to the first TRP may be transmitted on different Multiple Input Multiple Output (MIMO) layers than the N2 PUSCH transmissions to the second TRP.

In some aspects, the first repetition number N1 and the second repetition number N2 may be positive integers. In some aspects, a time-domain resource allocation (TDRA) field of the first DCI may indicate the first repetition number N1, and a TDRA field of the second DCI may indicate the second repetition number N2.

In some aspects, the first DCI may indicate the first TRP by indicating a first spatial relation and/or a first transmission configuration indicator (TCI) state, and the second DCI may indicate the second TRP by indicating a second spatial relation and/or a first TCI state. In some aspects, a first CORSET pool index of the first CORESET may indicate the first TRP, and a second CORSET pool index of the second CORESET may indicate the second TRP.

Yet another aspect of the invention may provide a user equipment (UE). The UE may be adapted to receive a first physical downlink control channel (PDCCH) that carries a first downlink control information (DCI) in a first Control Resource Set (CORESET). The first DCI and/or the first CORESET may indicate a first repetition number N1 and a first transmission and reception point (TRP). The UE may be adapted to receive a second PDCCH that carries a second DCI in a second CORESET. The second DCI and/or the second CORESET may indicate a second repetition number N2 and a second TRP, and the second TRP may be different than the first TRP. The UE may be adapted to transmit data associated with N1 physical uplink shared channel (PUSCH) transmissions associated with a transport block (TB) to the first TRP. The UE may be adapted to transmit data associated with N2 PUSCH transmissions associated with the same TB to the second TRP.

Still another aspect of the invention may provide a computer program comprising instructions for adapting an apparatus to perform the method of any one of the aspects above. Yet another aspect of the invention may provide a carrier containing the computer program, and the carrier may be one of an electronic signal, optical signal, radio signal, or compute readable storage medium.

Still another aspect of the invention may provide an apparatus. The apparatus may include processing circuitry and a memory. The memory may contain instructions executable by said processing circuitry, whereby said apparatus is operative to perform the method of any one of the aspects above.

Yet another aspect of the invention may provide a user equipment (UE) adapted to perform the method of any one of aspects above.

### BRIEF DESCRIPTION OF THE DRAWINGS

The accompanying drawings, which are incorporated herein and form part of the specification, illustrate various embodiments.

FIG. 1 illustrates NR time-domain structure with 15 kHz subcarrier spacing.

FIG. 2 illustrates an NR physical resource grid.

FIG. 3 illustrates a PUSCH scheduling restriction in NR.

FIG. 4 illustrates a second PUSCH scheduling restriction.

FIG. 5 illustrates out of order PUSCH scheduling when PDCCHs are from CORESETs with different CORESET pool indices.

FIG. 6 illustrates a user equipment that transmits data using PUSCH transmissions to two or more TRPS according to some embodiments.

FIG. 7 illustrates an example of scheduling PUSCH repetitions towards two TRPs by using two DCIs, each for scheduling multiple PUSCHs to one TRP according to some aspects.

FIG. 8 illustrates an example of multi-DCI based URLLC scheme with separate CORESET group/pool per TRP, according to some aspects.

FIGS. 9A, 9B, and 9C illustrate examples of multiple PUSCHs each scheduled by a separate DCI for a same TB on different times or slots, different frequency resources, and different MIMO layers, respectively, according to some aspects.

FIG. 10A is a flow chart illustrating a process performed by a user equipment according to some aspects.

FIG. 10B is a flow chart illustrating a process performed by a user equipment according to some aspects.

FIG. 11 is a block diagram of a user equipment according to some aspects.

FIG. 12 is a block diagram of a transmission and reception point (TRP) according to some aspects.

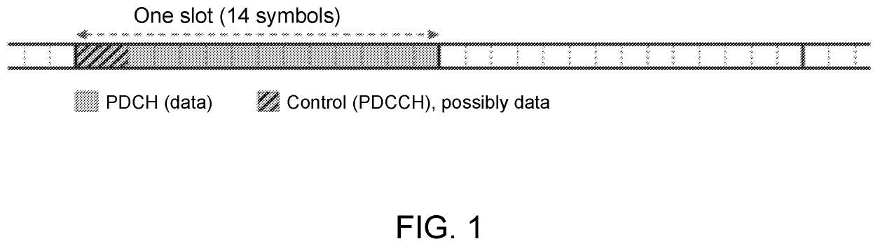

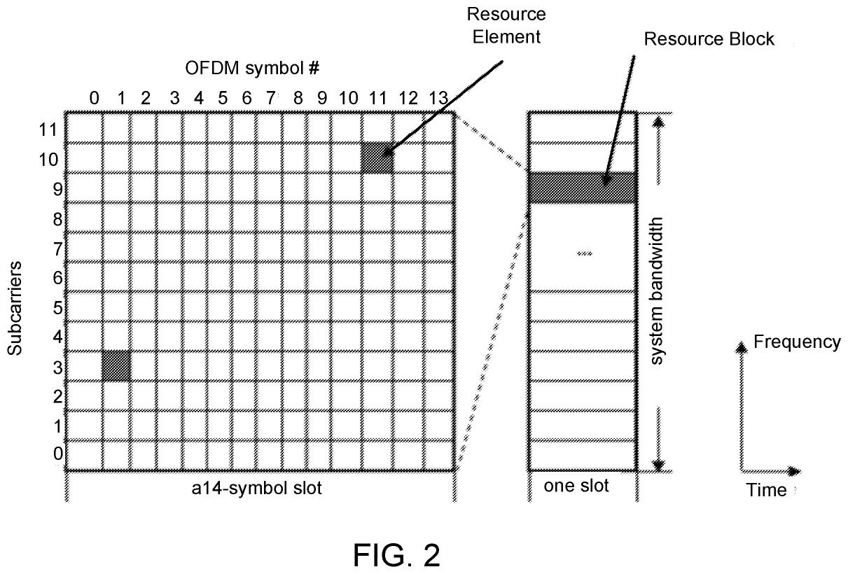

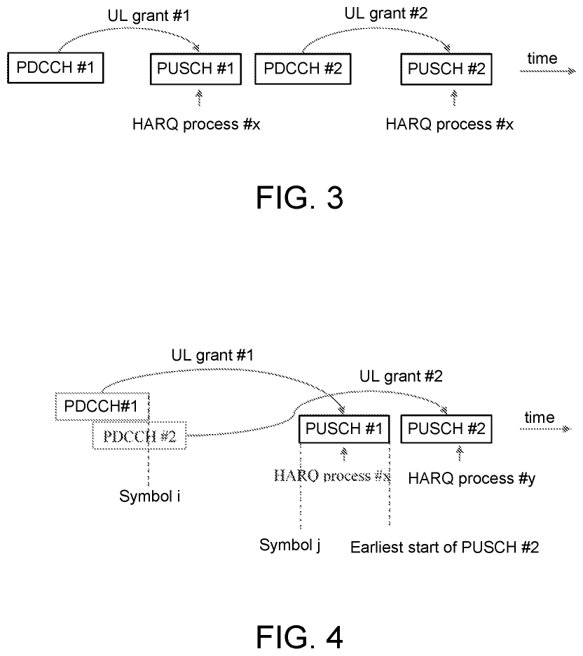

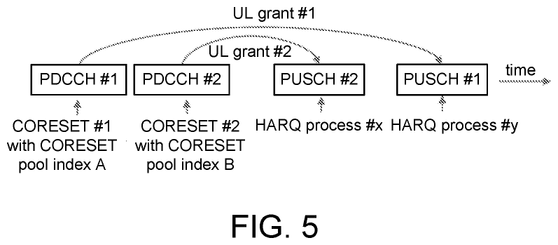

### DETAILED DESCRIPTION

### 2. Terminology

In this application, the term “node” can be a network node or a user equipment (UE). Examples of network nodes include, but are not limited to, a NodeB, a base station (BS), a multi-standard radio (MSR) radio node such as a MSR BS, an eNodeB, a gNodeB, a Master eNB (MeNB), a Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, remote radio unit (RRU), remote radio head (RRH), nodes in distributed antenna system (DAS), core network node (e.g. MSC, MME, etc.), O&M, OSS, SON, positioning node (e.g. E-SMLC).

In this application, the term “user equipment” or “UE” is a non-limiting term that refers to any type of wireless device communicating with a network node and/or with another UE in a cellular or mobile communication system. Examples of UEs include, but are not limited to, a target device, a device to device (D2D) UE, a vehicular to vehicular (V2V), a machine type UE, an machine type communication (MTC) UE, a UE capable of machine to machine (M2M) communication, a PDA, a Tablet, a mobile terminal(s), a smart phone, laptop embedded equipment (LEE), laptop mounted equipment (LME), and USB dongles.

In this application, the terms “radio network node,” “network node,” and “NW node” are generic terminology that refers to any kind of network node including but not limited to a base station, a radio base station, a base transceiver station, a base station controller, a network controller, an evolved Node B (eNB), a Node B, a gNodeB (gNB), a relay node, an access point (AP), a radio access point, a Remote Radio Unit (RRU), a Remote Radio Head (RRH), a Central Unit (e.g. in a gNB), a Distributed Unit (e.g. in a gNB), a Baseband Unit, a Centralized Baseband, and a C-RAN.

In this application, the term “transmission and reception point” or “TRP” is non-limiting terminology that refers to a network node (e.g., a base station) or a component of a network node, a spatial relation, or a transmission configuration indicator (TCI) state. In some aspects, a TRP may be represented by an SRS resource indicator (SRI), a CORESET pool index, a spatial relation, or a TCI state. In some embodiments, a TRP may be associated with multiple TCI states.

In this application, the term “radio access technology” or “RAT” may refer to any RAT including, for example and without limitation, UTRA, E-UTRA, narrow band internet of things (NB-IoT), WiFi, Bluetooth, next generation RAT, New Radio (NR), 4G, and 5G. Any of the equipment denoted by the terms “node,” “network node,” or “radio network node” may be capable of supporting a single or multiple RATs.

### 3. Aspects

3.1 Per TRP Scheduling for PUSCH Repetition Over Multiple TRPs for the Same TB

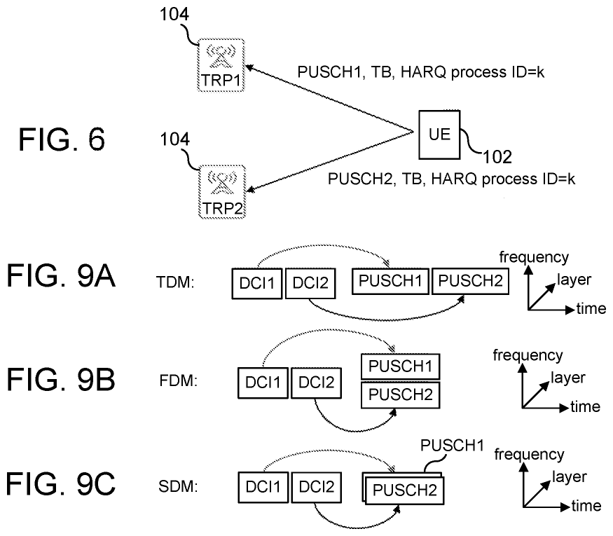

In some aspects, as shown in FIG. 6, a user equipment (UE) may transmit data using physical uplink shared channel (PUSCH) transmission to one or more TRPs 104 (e.g., TRP1 and TRP2). In some aspects, different DCIs may be used for PUSCH repetition over multiple TRPs for the same transport block (TB), with each of the different DCIs scheduling one or more PUSCHs to one TRP. This approach may provide the benefit that the existing DCI formats 0_1 and 0_2 can be used without introducing a new field. In addition, PUSCH scheduling parameters (e.g., time and frequency resource, modulation, and coding scheme) may be independently allocated for each TRP depending on its channel condition.

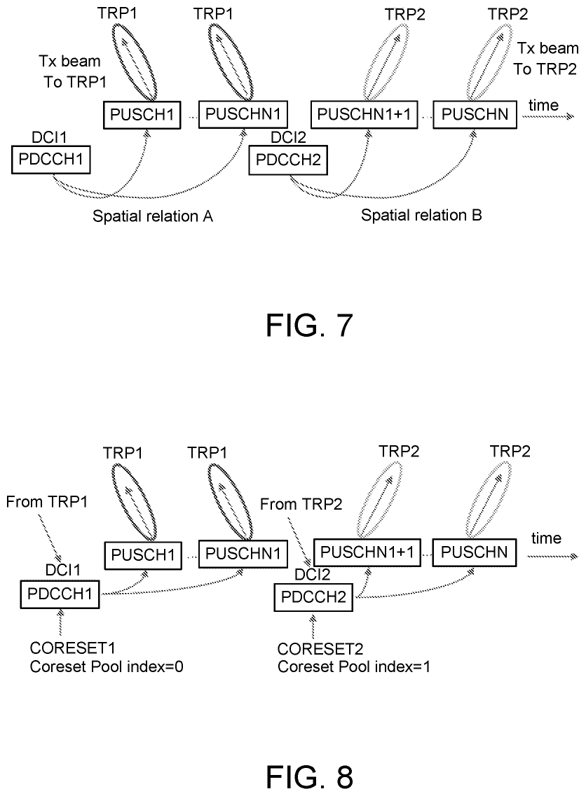

FIG. 7 illustrates an example in which two DCIs are used to schedule multiple PUSCHs to two TRPs 104. DCI #1 may be used to schedule N1 PUSCHs in N1 consecutive slots or sub-slots towards TRP #1, and DCI #2 may be used to schedule a remaining N2=N−N1 PUSCHs in N2 consecutive slots or sub-slots towards TRP #2. In some aspects, DCI #1 may be transmitted on a PDCCH #1, and DCI #2 may be transmitted on a PDCCH #2. In some aspects, all the N PUSCHs are for a same TB and are associated with a same hybrid automatic repeat request (HARQ) process ID. In some aspects, each of TRP #1 and TRP #2 may be represented by a spatial relation or a UL Transmission Configuration Indicator (TCI) state indicated in the DCI. In some aspects, the spatial relation may be implicitly indicated by an SRS resource indicator (SRI) field in the DCI, and the spatial relation of the PUSCH may be the same spatial relation of a SRS resource indicated by the SRI. In some aspects, the repetition number N1 or N2 may be indicated implicitly by the time-domain resource allocation (TDRA) field of the corresponding DCI.

In some aspects, the DCIs (e.g., DCI #1 and DCI #2) may be transmitted from a same TRP or different TRPs (e.g., DCI #1 and DCI #2 may be transmitted in a same CORESET with an activated TCI state associated with one TRP, or DCI #1 and DCI #2 may be transmitted in two CORESETs activated with two TCI states each associated with one of the TRPs).

In some aspects, the DCIs (e.g., DCI #1 and DCI #2) may be sent to the UE in a same slot or in different slots. In some aspects, if DCI #2 is received after DCI #1, DCI #2 may be received before the end of the last PUSCH scheduled by DCI #1. In some aspects, a same HARQ process ID and a same New Data Indicator (NDI) value may be contained in the multiple DCIs to indicate to a UE that the corresponding multiple PUSCHs carry a same TB.

In some aspects, the RV, modulation coding scheme (MCS), resource allocation, K2 (time offset between PDCCH to the corresponding PUSCH), power control command, number of layers, etc. may all be independently indicated in each DCI.

In some aspects, the encoded bits carried by each of the N PUSCHs may not be exactly the same (e.g., as different RVs may be used).

3.2 M-DCI Based Per TRP Scheduling for PUSCH Repetition Over Multiple TRPs

In some aspects, multiple (e.g. two, three, or more) CORESET pools may be configured, and each CORESET pool may be associated with a TRP. In some aspects, each of the multiple DCIs may be sent from a CORESET with a CORESET pool index. FIG. 8 illustrates an example of this embodiment where the UE is scheduled with N PUSCHs via two DCIs received from two CORESETs with different CORESET pool indices. In some aspects, the scheme illustrated in FIG. 8 may be a multi-DCI based Ultra-Reliable Low Latency Communication (URLLC) scheme. In some aspects, the multiple CORESETs may be activated with different TCI states, and each of the TCI states may be associated with one of the TRPs. In some aspects, each of the DCIs (e.g., DCI #1 and DCI #2) may schedule multiple PUSCH transmissions for the same TB to one TRP. In some aspects, all the N PUSCHs may be associated with a same TB, a same HARQ process ID, and a same value of NDI.

3.3 Extension to Simultaneous UL Transmission

In some aspects, as shown in FIGS. 7, 8, and 9A, the PUSCHs to different TRPs may be scheduled in different times or slots (e.g., in a time division multiplexing (TDM) fashion). In some alternative aspects, as shown in FIG. 9B, the PUSCHs to different TRPs may be scheduled on different frequency resources (e.g., in a frequency division multiplexing (FDM) fashion). In some alternative aspects, as shown in FIG. 9C, the PUSCHs to different TRPs may be scheduled on the same time and frequency resources but on different MIMO layers (e.g., in space division multiplexing (SDM) fashion). In the examples illustrated in FIGS. 9A-9C, N1=N2=1.

3.4 Flowcharts

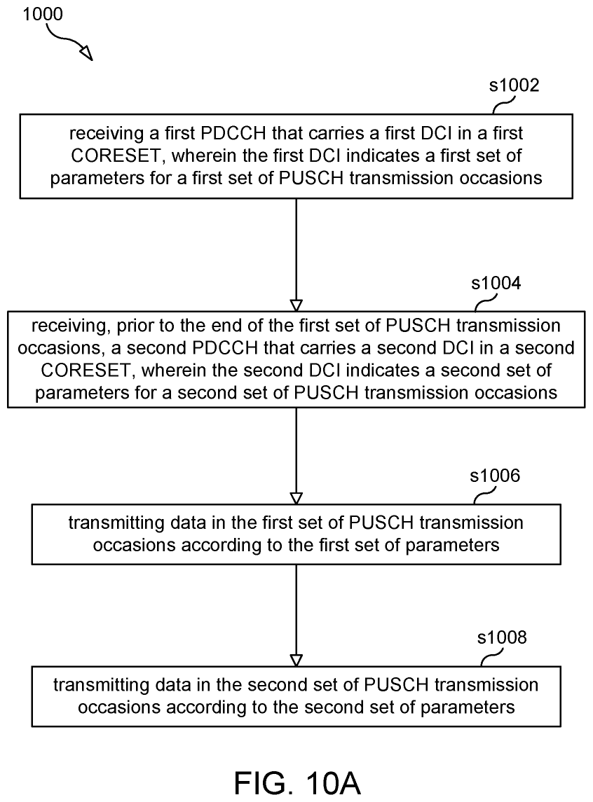

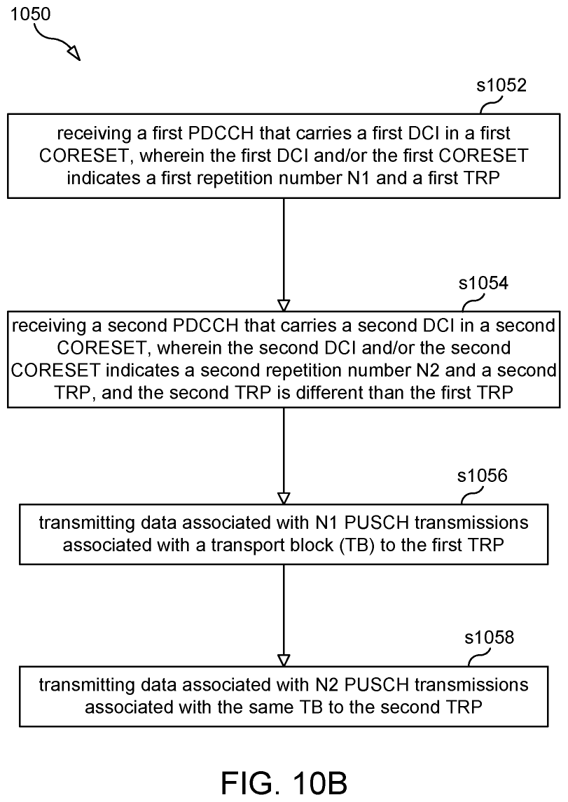

FIG. 10A illustrates a process 1000 performed by a user equipment (UE) 102 according to some aspects. In some aspects, the process 1000 may include a step 1002 in which the UE 102 receives a first physical downlink control channel (PDCCH) that carries a first downlink control information (DCI) in a first Control Resource Set (CORESET). In some aspects, the first DCI may indicate a first set of parameters for a first set of physical uplink shared channel (PUSCH) transmission occasions. In some aspects, the first set of parameters may include a first starting slot or sub-slot, a first Sounding Resource Indicator (SRI), a first uplink Transmission Control Indicator (TCI) state, a first Transmit Precoding Matrix Indicator (TPMI), and/or a first number N1 of PUSCH transmission occasions.

In some aspects, the process 1000 may include a step 1004 in which the UE 102 receives, prior to the end of the first set of PUSCH transmission occasions, a second PDCCH that carries a second DCI in a second CORESET. In some aspects, the second DCI may indicate a second set of parameters for a second set of PUSCH transmission occasions. In some aspects, the second set of parameters may include a second starting slot or sub-slot, a second SRI, a second uplink TCI state, a second TPMI, and/or a second number N2 of PUSCH transmission occasions.

In some aspects, the first CORESET and the second CORESET may be the same. In some alternative aspects, the first CORESET and the second CORESET may be different. In some aspects, the first CORESET may be activated with a first downlink transmission configuration indicator (TCI) state, and the second CORESET may be activated with a second downlink TCI state. In some aspects, the first and second downlink TCI states may be the same. In some aspects, the first and second downlink TCI states may be different. In some alternative aspects, as shown in FIG. 8, the first and the second CORESETs may be configured with different CORESET pool indices.

In some aspects, the first DCI and the second DCI may be received in a same slot. In some alternative aspects, the first DCI and the second DCI may be received in different slots.

In some aspects, the process 1000 may include a step 1006 in which the UE 102 transmits data in the first set of PUSCH transmission occasions according to the first set of parameters. In some aspects, the process 1000 may include a step 1008 in which the UE 102 transmits data in the second set of PUSCH transmission occasions according to the second set of parameters. In some aspects, the data transmitted in the first set of PUSCH transmission occasions according to the first set of parameters and the data transmitted in the second set of PUSCH transmission occasions according to the second set of parameters may be the same.

In some aspects, the first set of parameters may include a first starting slot or sub-slot, the second set of parameters may include a second starting slot or sub-slot, transmitting data in the first set of PUSCH transmission occasions in step 1006 may include transmitting data in N1 consecutive slots or sub-slots starting from the first starting slot or sub-slot, and transmitting the data in the second set of PUSCH transmission occasions in step 1008 may include transmitting the data in N2 consecutive slots or sub-slots starting from the second starting slot or sub-slot.

In some aspects, the first set of PUSCH transmission occasions may include a first number N1 of PUSCH transmission occasions, and the second set of PUSCH transmission occasions may include a second number N2 of PUSCH transmission occasions. In some aspects, the N1 PUSCH transmission occasions and the N2 PUSCH transmission occasions may be associated with a same hybrid automatic repeat request (HARQ) process number. In some aspects, the N1 PUSCH transmission occasions and the N2 PUSCH transmission occasions may be associated with a same value of New Data Indicator (NDI).

In some aspects, as shown in FIG. 7, the N1 PUSCH transmission occasions may be associated with a first spatial relation, the N2 PUSCH transmissions may be associated with a second spatial relation, and the first and second spatial relations may be different. In some aspects, a sounding reference signal resource indicator (SRI) field in the first DCI may indicate a first SRI and the first spatial relation, and an SRI field in the second DCI may indicate a second SRI and the second spatial relation.

In some aspects, as shown in FIGS. 7, 8, and 9A, the N1 PUSCH transmission occasions and the N2 PUSCH transmission occasions may not overlap in time. In some aspects, as shown in FIGS. 7, 8, and 9A, the N1 PUSCH transmission occasions may be transmitted at different times or slots than the N2 PUSCH transmission occasions. In some aspects, as shown in FIGS. 9B and 9C, the N1 PUSCH transmission occasions may be transmitted at the same time as the N2 PUSCH transmission occasions. In some aspects, as shown in FIG. 9B, the N1 PUSCH transmission occasions may be transmitted on different frequency resources than the N2 PUSCH transmission occasions. In some aspects, as shown in FIGS. 9A and 9C, the N1 PUSCH transmission occasions may be transmitted on the same frequency resources as the N2 PUSCH transmission occasions. In some aspects, as shown in FIG. 9C, the N1 PUSCH transmission occasions may be transmitted on different Multiple Input Multiple Output (MIMO) layers than the N2 PUSCH transmission occasions.

In some aspects, the first number N1 of PUSCH transmission occasions and the second number N2 of PUSCH transmission occasions may be positive integers (e.g., 1, 2, 3, 4, etc.). In some aspects, a time-domain resource allocation (TDRA) field of the first DCI may indicate the first number N1 of PUSCH transmission occasions, and a TDRA field of the second DCI may indicate the second number N2 of PUSCH transmission occasions.

In some aspects, the first set of parameters may be associated with a first transmission and reception point (TRP) 104 (e.g., TRP #1), the second set of parameters may be associated with a second TRP 104 (e.g., TRP #2), and the first and second TRPs 104 may be different. In some aspects, the data transmitted in the first set of PUSCH transmission occasions may be transmitted to the first TRP 104, and the data transmitted in the second set of PUSCH transmission occasions may be transmitted to the second TRP 104. In some aspects, the first DCI may indicate the first TRP 104 by indicating a first sounding reference signal resource indicator (SRI), a first spatial relation, and/or a first uplink transmission configuration indicator (TCI) state, and the second DCI may indicate the second TRP 104 by indicating a second SRI, a second spatial relation, and a second uplink TCI state. In some aspects, a first CORSET pool index of the first CORESET may indicate the first TRP 104, and a second CORSET pool index of the second CORESET may indicate the second TRP 104.

FIG. 10B illustrates a process 1050 performed by a user equipment (UE) 102 according to some aspects. In some aspects, the process 1050 may include a step 1052 in which the UE 102 receives a first physical downlink control channel (PDCCH) that carries a first downlink control information (DCI) in a first Control Resource Set (CORESET). In some aspects, the first DCI and/or the first CORESET may indicate a first repetition number N1 and a first transmission and reception point (TRP) 104 (e.g., TRP #1). In some aspects, the first repetition number N1 may be a positive integer (e.g., 1, 2, 3, 4, etc.).

In some aspects, the process 1050 may include a step 1054 in which the UE 102 receives a second PDCCH that carries a second DCI in a second CORESET. In some aspects, the second DCI and/or the second CORESET may indicate a second repetition number N2 and a second TRP 104 (e.g., TRP #2), and the second TRP may be different than the first TRP. In some aspects, the second repetition number N2 may be a positive integer (e.g., 1, 2, 3, 4, etc.). In some aspects, a time-domain resource allocation (TDRA) field of the first DCI may indicate the first repetition number N1, and a TDRA field of the second DCI may indicate the second repetition number N2.

In some aspects, the first DCI and the second DCI may be received in the same slot. In some alternative aspects, the first DCI and the second DCI may be received in different slots. If some aspects, if the second DCI is received after the first DCI, the second DCI may be received before the end of the last PUSCH scheduled by the first DCI is transmitted.

In some aspects, the first CORESET and the second CORESET may be the same. In some alternative aspects, the first CORESET and the second CORESET may be different. In some aspects, the first CORESET may be activated with a first transmission configuration indicator (TCI) state, and the second CORESET may be activated with a second TCI state. In some aspects, the first and second TCI states may be the same. In some aspects, the first and second TCI states may be different. In some aspects, as shown in FIG. 8, the first and the second CORESETs may be configured with different CORESET pool indices.

In some aspects, the first DCI may indicate the first TRP by indicating a first spatial relation and/or a first TCI state, and the second DCI may indicate the second TRP by indicating a second spatial relation and/or a second TCI state. In some aspects, a first CORSET pool index of the first CORESET may indicate the first TRP, and a second CORSET pool index of the second CORESET may indicate the second TRP.

In some aspects, the process 1050 may include a step 1056 in which the UE 102 transmits data associated with N1 physical uplink shared channel (PUSCH) transmissions associated with a transport block (TB) to the first TRP.

In some aspects, the process 1050 may include a step 1058 in which the UE 102 transmits data associated with N2 PUSCH transmissions associated with the same TB to the second TRP.

In some aspects, transmitting data associated with the N1 PUSCH transmissions to the first TRP in step 1056 may include transmitting data associated with N1 consecutive slots or sub-slots, and transmitting the data associated with the N2 PUSCH transmissions to the second TRP in step 1058 may include transmitting the data associated with N2 consecutive slots or sub-slots. In some aspects, the N1 PUSCH transmissions to the first TRP and the N2 PUSCH transmissions to the second TRP may be associated with a same hybrid automatic repeat request (HARQ) process identification (ID). In some aspects, the N1 PUSCH transmissions to the first TRP and the N2 PUSCH transmissions to the second TRP may be associated with a same value of New Data Indicator (NDI).

In some aspects, as shown in FIG. 7, the N1 PUSCH transmissions to the first TRP may be associated with a first spatial relation, the N2 PUSCH transmissions to the second TRP may be associated with a second spatial relation, and the first and second spatial relations may be different. In some aspects, the first DCI may indicate the first spatial relation, and the second DCI may indicate the second spatial relation. In some aspects, the first spatial relation may represent the first TRP, and the second spatial relation may represent the second TRP. In some aspects, an SRI field in the first DCI may indicate the first spatial relation, and an SRI field in the second DCI may indicate the second spatial relation.

In some aspects, as shown in FIGS. 7, 8, and 9A, the N1 PUSCH transmissions to the first TRP and the N2 PUSCH transmissions to the second TRP may not overlap in time. In some aspects, as shown in FIGS. 7, 8, and 9A, the N1 PUSCH transmissions to the first TRP may be transmitted at different times or slots than the N2 PUSCH transmissions to the second TRP. In some aspects, as shown in FIGS. 9B and 9C, the N1 PUSCH transmissions to the first TRP may be transmitted at the same time as the N2 PUSCH transmissions to the second TRP. In some aspects, as shown in FIG. 9B, the N1 PUSCH transmissions to the first TRP may be transmitted on different frequency resources than the N2 PUSCH transmissions to the second TRP. In some aspects, as shown in FIGS. 9A and 9C, the N1 PUSCH transmissions to the first TRP may be transmitted on the same frequency resources as the N2 PUSCH transmissions to the second TRP. In some aspects, as shown in FIG. 9C, the N1 PUSCH transmissions to the first TRP may be transmitted on different Multiple Input Multiple Output (MIMO) layers than the N2 PUSCH transmissions to the second TRP.

In some aspects, if the second DCI is received later than the first DCI, the second DCI may be received before the last of the N1 PUSCH transmissions scheduled by the first DCI is transmitted.

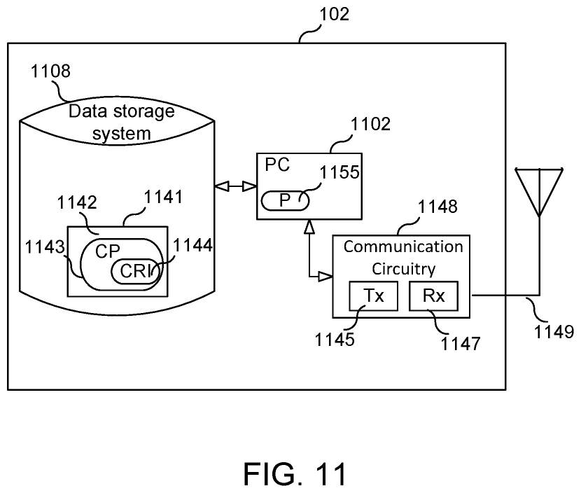

FIG. 11 is a block diagram of UE 102, according to some aspects. As shown in FIG. 11, UE 102 may comprise: processing circuitry (PC) 1102, which may include one or more processors (P) 1155 (e.g., one or more general purpose microprocessors and/or one or more other processors, such as an application specific integrated circuit (ASIC), field-programmable gate arrays (FPGAs), and the like); communication circuitry 1148, which is coupled to an antenna arrangement 1149 comprising one or more antennas and which comprises a transmitter (Tx) 1145 and a receiver (Rx) 1147 for enabling UE 102 to transmit data and receive data (e.g., wirelessly transmit/receive data); and a local storage unit (a.k.a., “data storage system”) 1108, which may include one or more non-volatile storage devices and/or one or more volatile storage devices. In some aspects where PC 1102 includes a programmable processor, a computer program product (CPP) 1141 may be provided. CPP 1141 includes a computer readable medium (CRM) 1142 storing a computer program (CP) 1143 comprising computer readable instructions (CRI) 1144. CRM 1142 may be a non-transitory computer readable medium, such as, magnetic media (e.g., a hard disk), optical media, memory devices (e.g., random access memory, flash memory), and the like. In some aspects, the CRI 1144 of computer program 1143 is configured such that when executed by PC 1102, the CRI causes UE 102 to perform steps described herein (e.g., steps described herein with reference to the flow chart). In other aspects, UE 102 may be configured to perform steps described herein without the need for code. That is, for example, PC 1102 may consist merely of one or more ASICs. Hence, the features of the aspects described herein may be implemented in hardware and/or software.

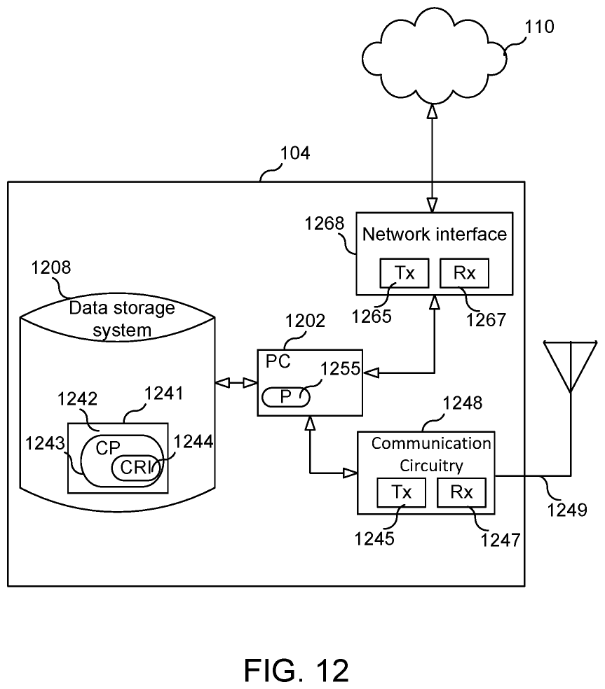

FIG. 12 is a block diagram of a TRP 104 (e.g., a network node such as a base station or a component thereof), according to some aspects. As shown in FIG. 12, the TRP 104 may comprise: processing circuitry (PC) 1202, which may include one or more processors (P) 1255 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., the TRP 104 may be a distributed computing apparatus); a network interface 1268 comprising a transmitter (Tx) 1265 and a receiver (Rx) 1267 for enabling the TRP 104 to transmit data to and receive data from other nodes connected to a network 110 (e.g., an Internet Protocol (IP) network) to which network interface 1268 is connected; communication circuitry 1248, which is coupled to an antenna arrangement 1249 comprising one or more antennas and which comprises a transmitter (Tx) 1245 and a receiver (Rx) 1247 for enabling the network node 104 to transmit data and receive data (e.g., wirelessly transmit/receive data); and a local storage unit (a.k.a., “data storage system”) 1208, which may include one or more non-volatile storage devices and/or one or more volatile storage devices. In aspects where PC 1202 includes a programmable processor, a computer program product (CPP) 1241 may be provided. CPP 1241 includes a computer readable medium (CRM) 1242 storing a computer program (CP) 1243 comprising computer readable instructions (CRI) 1244. CRM 1242 may be a non-transitory computer readable medium, such as, magnetic media (e.g., a hard disk), optical media, memory devices (e.g., random access memory, flash memory), and the like. In some aspects, the CRI 1244 of computer program 1243 is configured such that when executed by PC 1202, the CRI causes the TRP 104 to perform steps (e.g., the TRP-side of one or more UE-side steps described herein with reference to the flow charts). In other aspects, the TRP 104 may be configured to perform steps described herein without the need for code. That is, for example, PC 1902 may consist merely of one or more ASICs. Hence, the features of the aspects described herein may be implemented in hardware and/or software.

### SUMMARY OF EMBODIMENTS

A1. A method (1050) performed by a user equipment (UE) (102), the method comprising at least one of: receiving a first physical downlink control channel (PDCCH) that carries a first downlink control information (DCI) in a first Control Resource Set (CORESET), wherein the first DCI and/or first CORESET indicates a first repetition number N1 and a first transmission and reception point (TRP); receiving a second PDCCH that carries a second DCI in a second CORESET, wherein the second DCI and/or second CORESET indicates a second repetition number N2 and a second TRP, and the second TRP is different than the first TRP; transmitting data associated with N1 physical uplink shared channel (PUSCH) transmissions associated with a transport block (TB) to the first TRP; and transmitting data associated with N2 PUSCH transmissions associated with the same TB to the second TRP.

A2. The method of embodiment A1, wherein the first CORESET and the second CORESET are the same.

A3. The method of embodiment A1, wherein the first CORESET and the second CORESET are different.

A4. The method of any one of embodiments A1-A3, wherein the first CORESET is activated with a first transmission configuration indicator (TCI) state, and the second CORESET is activated with a second TCI state.

A5. The method of embodiment A4, wherein the first and second TCI states are the same.

A6. The method of embodiment A4, wherein the first and second TCI states are

different.

A7. The method of any one of embodiments A1-A6, wherein the first and the second CORESETs are configured with different CORESET pool indices.

A8. The method of any one of embodiments A1-A7, wherein transmitting data associated with the N1 PUSCH transmissions to the first TRP comprises transmitting data associated with N1 consecutive slots or sub-slots, and transmitting the data associated with the N2 PUSCH transmissions to the second TRP comprises transmitting the data associated with N2 consecutive slots or sub-slots.

A9. The method of any one of embodiments A1-A8, wherein the N1 PUSCH transmissions to the first TRP and the N2 PUSCH transmissions to the second TRP are associated with a same hybrid automatic repeat request (HARQ) process identification (ID).

A10. The method of any one of embodiments A1-A9, wherein the N1 PUSCH transmissions to the first TRP and the N2 PUSCH transmissions to the second TRP are associated with a same value of New Data Indicator (NDI).

A11. The method of any one of embodiments A1-A10, wherein the first DCI and the second DCI are received in the same slot.

A12. The method of any one of embodiments A1-A10, wherein the first DCI and the second DCI are received in different slots.

A12a. The method of any one of embodiments A1-A12, wherein, if the second DCI is received later than the first DCI, the second DCI is received before the last of the N1 PUSCH transmissions scheduled by the first DCI is transmitted.

A13. The method of any one of embodiments A1-A12A, wherein the N1 PUSCH transmissions to the first TRP are associated with a first spatial relation, the N2 PUSCH transmissions to the second TRP are associated with a second spatial relation, and the first and second spatial relations are different.

A14. The method of embodiment A13, wherein the first DCI indicates the first spatial relation, and the second DCI indicates the second spatial relation.

A15. The method of embodiment A13 or A14, wherein the first spatial relation represents the first TRP, and the second spatial relation represents the second TRP.

A16. The method of any one of embodiments A13-A15, wherein a sounding reference signal resource indicator (SRI) field in the first DCI indicates the first spatial relation, and an SRI field in the second DCI indicates the second spatial relation.

A17. The method of any one of embodiments A1-A16, wherein the N1 PUSCH transmissions to the first TRP and the N2 PUSCH transmissions to the second TRP do not overlap in time.

A18. The method of any one of embodiments A1-A17, wherein the N1 PUSCH transmissions to the first TRP are transmitted at different times or slots than the N2 PUSCH transmissions to the second TRP.

A19. The method of any one of embodiments A1-A17, wherein the N1 PUSCH transmissions to the first TRP are transmitted at the same time as the N2 PUSCH transmissions to the second TRP.

A20. The method of any one of embodiments A1-A19, wherein the N1 PUSCH transmissions to the first TRP are transmitted on different frequency resources than the N2 PUSCH transmissions to the second TRP.

A21. The method of any one of embodiments A1-A19, wherein the N1 PUSCH transmissions to the first TRP are transmitted on the same frequency resources as the N2 PUSCH transmissions to the second TRP.

A22. The method of any one of embodiments A1-A21, wherein the N1 PUSCH transmissions to the first TRP are transmitted on different Multiple Input Multiple Output (MIMO) layers than the N2 PUSCH transmissions to the second TRP.

A23. The method of any one of embodiments A1-A22, wherein the first repetition number N1 and the second repetition number N2 are positive integers.

A24. The method of any one of embodiments A1-A23, wherein a time-domain resource allocation (TDRA) field of the first DCI indicates the first repetition number N1, and a TDRA field of the second DCI indicates the second repetition number N2.

A25. The method of any one of embodiments A1-A24, wherein the first DCI indicates the first TRP by indicating a first spatial relation and/or a first transmission configuration indicator (TCI) state, and the second DCI indicates the second TRP by indicating a second spatial relation and/or a first TCI state.

A26. The method of any one of embodiments A1-A24, wherein a first CORSET pool index of the first CORESET indicates the first TRP, and a second CORSET pool index of the second CORESET indicates the second TRP.

B1. A user equipment (UE) (102) adapted to perform at least one of: receiving a first physical downlink control channel (PDCCH) that carries a first downlink control information (DCI) in a first Control Resource Set (CORESET), wherein the first DCI and/or first CORESET indicates a first repetition number N1 and a first transmission and reception point (TRP); receiving a second PDCCH that carries a second DCI in a second CORESET, wherein the second DCI and/or second CORESET indicates a second repetition number N2 and a second TRP, and the second TRP is different than the first TRP; transmitting data associated with N1 physical uplink shared channel (PUSCH) transmissions associated with a transport block (TB) to the first TRP; and transmitting data associated with N2 PUSCH transmissions associated with the same TB to the second TRP.

C1. A computer program comprising instructions for adapting an apparatus to perform the method of any one of embodiments A1-A26.

D1. A carrier containing the computer program of embodiment C1, wherein the carrier is one of an electronic signal, optical signal, radio signal, or compute readable storage medium.

E1. An apparatus (102), the apparatus comprising: processing circuitry (1102); and a memory (1142), said memory containing instructions (1644 or 1944) executable by said processing circuitry, whereby said apparatus is operative to perform the method of any one of the embodiments A1-A26.

F1. A user equipment (UE) (102) adapted to perform the method of any one of embodiments A 1-A26.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a user equipment (UE), the method comprising:
receiving a first physical downlink control channel (PDCCH) that carries a first downlink control information (DCI) in a first Control Resource Set (CORESET), wherein the first DCI indicates a first set of parameters for a first set of physical uplink shared channel (PUSCH) transmission occasions;
receiving, prior to the end of the first set of PUSCH transmission occasions, a second PDCCH that carries a second DCI in a second CORESET, wherein the second DCI indicates a second set of parameters for a second set of PUSCH transmission occasions;
transmitting data in the first set of PUSCH transmission occasions according to the first set of parameters; and
transmitting data in the second set of PUSCH transmission occasions according to the second set of parameters.

2. The method of claim 1, wherein the first set of parameters comprises a first starting slot or sub-slot, a first Sounding Resource Indicator (SRI), a first uplink Transmission Control Indicator (TCI) state, a first Transmit Precoding Matrix Indicator (TPMI), and/or a first number N1 of PUSCH transmission occasions.

3. The method of claim 2, wherein the second set of parameters comprises a second starting slot or sub-slot, a second SRI, a second uplink TCI state, a second TPMI, and/or a second number N2 of PUSCH transmission occasions.

4. (canceled)

5. (canceled)

6. The method of claim 1, wherein the first CORESET is activated with a first downlink transmission configuration indicator (TCI) state, and the second CORESET is activated with a second downlink TCI state.

7. (canceled)

8. (canceled)

9. The method of claim 1, wherein the first and the second Coresets are configured with different CORESET pool indices.

10. The method of claim 1, wherein the first set of parameters comprises a first starting slot or sub-slot, the second set of parameters comprises a second starting slot or sub-slot, transmitting data in the first set of PUSCH transmission occasions comprises transmitting data in N1 consecutive slots or sub-slots starting from the first starting slot or sub-slot, and transmitting the data in the second set of PUSCH transmission occasions comprises transmitting the data in N2 consecutive slots or sub-slots starting from the second starting slot or sub-slot.

11. (canceled)

12. (canceled)

13. The method of claim 1, wherein the first set of PUSCH transmission occasions comprises a first number N1 of PUSCH transmission occasions, and the second set of PUSCH transmission occasions comprises a second number N2 of PUSCH transmission occasions.

14. The method of claim 13, wherein the N1 PUSCH transmission occasions and the N2 PUSCH transmission occasions are associated with a same hybrid automatic repeat request (HARD) process number.

15. The method of claim 13, wherein the N1 PUSCH transmission occasions and the N2 PUSCH transmission occasions are associated with a same value of New Data Indicator (NDI).

16. The method of claim 13, wherein the N1 PUSCH transmission occasions are associated with a first spatial relation, the N2 PUSCH transmissions are associated with a second spatial relation, and the first and second spatial relations are different.

17. The method of claim 16, wherein a sounding reference signal resource indicator (SRI) field in the first DCI indicates a first SRI and the first spatial relation, and an SRI field in the second DCI indicates a second SRI and the second spatial relation.

18-22. (canceled)

23. The method of claim 13, wherein the N1 PUSCH transmission occasions are transmitted on different Multiple Input Multiple Output (MIMO) layers than the N2 PUSCH transmission occasions.

24. The method of claim 13, wherein the first number N1 of PUSCH transmission occasions and the second number N2 of PUSCH transmission occasions are positive integers.

25. The method of claim 13, wherein a time-domain resource allocation (TDRA) field of the first DCI indicates the first number N1 of PUSCH transmission occasions, and a TDRA field of the second DCI indicates the second number N2 of PUSCH transmission occasions.

26. The method of claim 1, wherein the first set of parameters are associated with a first transmission and reception point (TRP), the second set of parameters are associated with a second TRP, and the first and second TRPs are different.

27. The method of claim 26, wherein the data transmitted in the first set of PUSCH transmission occasions is transmitted to the first TRP, and the data transmitted in the second set of PUSCH transmission occasions is transmitted to the second TRP.

28. The method of claim 26, wherein the first DCI indicates the first TRP by indicating a first sounding reference signal resource indicator (SRI), a first spatial relation, and/or a first uplink transmission configuration indicator (TCI) state, and the second DCI indicates the second TRP by indicating a second SRI, a second spatial relation, and a second uplink TCI state.

29. The method of claim 26, wherein a first CORSET pool index of the first CORESET indicates the first TRP, and a second CORSET pool index of the second CORESET indicates the second TRP.

30. (canceled)

31. A user equipment (UE) adapted to:
receive a first physical downlink control channel (PDCCH) that carries a first downlink control information (DCI) in a first Control Resource Set (CORESET), wherein the first DCI indicates a first set of parameters for N1 physical uplink shared channel (PUSCH) transmission occasions;
receive, prior to the end of the first set of PUSCH transmission occasions, a second PDCCH that carries a second DCI in a second CORESET, wherein the second DCI indicates a second set of parameters for N2 PUSCH transmission occasions;
transmit data in the N1 PUSCH transmission occasions according to the first set of parameters; and
transmit data in the N2 PUSCH transmission occasions according to the second set of parameters.

32. (canceled)

33. (canceled)

34. The UE of claim 31, comprising:
processing circuitry; and
a memory containing instructions executable by said processing circuitry, whereby said UE is operative to perform receiving the first PDCH, receiving the second PDCCH, transmitting the data in the N1 PUSCH transmission occasions, and transmitting the data in the N2 PUSCH transmission occasions.

35. (canceled)
